(19) United States
(12) Patent Application Publication
(10) Pub. No.: US 2010/0118923 A1
(43) Pub. Date: May 13, 2010

(54) PROGRAMMABLE WIDE BAND DIGITAL RECEIVER/TRANSMITTER

(76) Inventor: Debajyoti Pal, Saratoga, CA (US)

Correspondence Address: Haynes and Boone, LLP;IP Section, 2323 Victory Avenue, SUITE 700, Dallas, TX, 75219, US

(21) Appl. No.: 12/268,994

(22) Filed: Nov. 11, 2008

Related U.S. Application Data
(62) Division of application No. 12/268,940, filed on Nov. 11, 2008.

(51) Int. Cl. H04B 1/40

(52) U.S. Cl. 375/219

(57) ABSTRACT

A receiver uses a wideband intermediate frequency (IF) in the analog domain and performs low IF down-conversion in the digital domain, using low-power, high-speed, high resolution analog-to-digital converters. The receiver can be integrated into an integrated circuit as one of several receivers. Such an integrated circuit may include multiple transmitters using adaptive non-linear modeling pre-distortion. The non-linear modeling may include memory. Imbalance in intermediate frequency in-phase and quadrature signals may be corrected in the digital domains. DC offsets in the intermediate signal may be corrected in both analog and digital domains. In one instance, the receiver provides a feedback receiver for the adaptive pre-distorter in a transmitter on the integrated circuit.

### CROSS REFERENCE TO RELATED APPLICATIONS

The present application is a division of U.S. patent application Ser. No. 12/268,940 filed on Nov. 11, 2008, incorporated herein by reference.

### BACKGROUND OF THE INVENTION

1. Field of the Invention

The present invention relates to wireless communication. In particular, the present invention relates to low-power, wide band transmitter and receiver designs.

2. Discussion of the Related Art

In wireless communication, power consumption in the receiver and transmitter units is an important design consideration. In transmitter and receiver designs for conventional mobile devices, largely out of power consideration in the analog-to-digital (A/D) converter, digital signal processing is typically performed in the baseband. FIG. 1(a) is a block diagram of a first example of a conventional RF transceiver design. As shown in FIG. 1(a), conventional RF transceiver 100 includes antenna 101, which is shared between transmitting and receiving operations under control of transmitter/receiver switch 102. When transmitting, the narrow-band, base band signal to be transmitted is prepared in digital base band processor 109 and converted in D/A converter 107 into an analog signal, which is received into analog transceiver 106, where the signal is filtered and up-converted (e.g., modulated onto a carrier signal). Surface acoustic wave (SAW) filter 104 is typically provided to limit the output signal to the selected band. Power amplifier 103 then drives the filtered signal onto antenna 101 through transmitter/receiver switch 102. When receiving, the signal in antenna 101 is band-limited by receiver band select SAW filter 105. Analog transceiver 106 processes the filtered signal and down-converts the processed signal into a narrow-band, base band signal, which is digitized in A/D converter 108. The digitized signal is then processed in digital base band processor 109.

FIG. 1(b) is a block diagram of a second example of a conventional RF transceiver design 120, in which D/A converter 107 and A/D converter 108 are integrated into digital base band processor 109. Such integration may be achieved, for example, by providing digital base band processor 109, D/A converter 107 and A/D converter 108 in the same integrated circuit package or on the same semiconductor die 121. Alternatively, D/A converter 107 and A/D converter 108 may be integrated with RF transceiver 106 in the same integrated circuit package or on the same semiconductor die 141, as shown in FIG. 1(c).

RF transceiver 106 may include a heterodyne receiver. FIG. 2 is a block diagram of conventional heterodyne receiver 200. As shown in FIG. 2, heterodyne receiver 200 includes low-noise amplifier (LNA) 201, which amplifies the received signal for processing. Prior to down-conversion, image reject filter 202, which may be implemented in the form of a SAW filter, a passive inductor-capacitor (LC) circuit, or a suitable integrated circuit, is provided to eliminate any undesirable image signal which may corrupt the down-converted signal. The filtered signal is then mixed at mixer 203 to modulate an intermediate frequency (IF) signal. IF channel select filter 204, which may be implemented by a SAW filter, further band-limit the down-converted signal to the desired channel. Variable gain amplifier 205 then adjusts the amplitude of the IF signal. A second down-conversion at local oscillator 207 and mixers 206a and 206b provides in-phase and quadrature signals at the baseband. Local oscillator 207 may be provided by a fine tunable local oscillator. The baseband in-phase and quadrature signals are filtered at low-pass filters 208a and 208b (preferably, with automatic gain control), which is then digitized at A/D converters 108a and 108b for further processing in base band processor 109.

In general, a conventional heterodyne receiver has good sensitivity and selectivity. However, the conventional heterodyne receiver has a large number of components that are not suitable for integration and thus have to be provided externally. For example, the IF channel select filter (e.g., IF channel select filter 204) requires a low phase noise oscillator. Such a low phase noise oscillator typically requires an external high Q-value transformer. In the implementation of FIG. 2, the LNA need also be matched to a 50-ohm output impedance.

Another conventional receiver design is the homodyne receiver (also referred to as the “Zero-IF” receiver, or the “direct conversion” receiver), illustrated in FIG. 3. As shown in FIG. 3, homodyne receiver 300 includes LNA 301, which amplifies a band-limited signal from band select filter 105. The filtered signal is then down-converted at local oscillator 302 and mixed at mixers 302a and 302b to provide in-phase and quadrature signals at the baseband. Local oscillator 302 may be provided by a fine tunable local oscillator. The baseband in-phase and quadrature signals are amplified at variable gain amplifiers 304a and 304b and filtered at low-pass filters 305a and 305b (preferably, with automatic gain control), which is then digitized at A/D converters 108a and 108b for further processing in base band processor 109.

A homodyne receiver has the advantage over a heterodyne receiver of not requiring an image rejection filter or IF filter. Without such a requirement, the homodyne filter requires substantially less number of external components and is therefore easier to integrate. In addition, without the requirement of an image reject filter, LNA 301 need not be matched to a 50-ohm output impedance. However, for channel selection purpose, a homodyne receiver requires a low phase noise fine tunable local oscillator to implement local oscillator 302, and high-order, multi-stage analog low-pass filters to implement low-pass filters 305a and 305b. Further, homodyne receivers are sensitive to 1/f noise, DC offset and I/Q imbalance.

In the prior art, IQ imbalance are corrected for mismatch in the quadrature mixing stage, and imbalances due to branch filters (e.g., low-pass filters 305a and 305b), automatic gain control (AGC) stages, and A/D converters are disregarded. However, this approach is inadequate and often leading to poor image rejection.

Another conventional receiver is a low IF receiver, which is substantially similar to the homodyne receiver discussed above. FIG. 4 is a block diagram of conventional low IF receiver 400. However, unlike homodyne receiver 300 of FIG. 3, low IF receiver 400 down-converts in the analog domain only to a low intermediate frequency (e.g., several megahertz). Therefore, narrow-band channel select filters 401a and 401b are provided, rather than low-pass filters 305a and 305b. The final down-conversion to base band, rate matching and filter are performed digitally (illustrated by down-conversion process 402), as shown in FIG. 4. As the low IF receiver is similar to the homodyne receiver, the advantages and disadvantages of the IF receiver vis à vis the heterodyne receiver are substantially those of the homodyne receiver.

Another conventional receiver is a wide band IF receiver. FIG. 5 is a block diagram of conventional wide band IF receiver 500. As shown in FIG. 5, wide band IF receiver 500 includes LNA 501, which amplifies a band-limited signal from band select filter 105. The filtered signal is then down-converted to an intermediate frequency at local oscillator 502 and mixed at mixers 502a and 502b to provide in-phase and quadrature signals at an IF. The IF in-phase and quadrature signals are then filtered in wide band low-pass filters 503a and 593b. A second down-conversion is then performed to provide base band in-phase and quadrature signals. This second down-conversion is performed at mixers 506a, 506b, 506c and 506d and summers 507a and 507b, using signals generated by local oscillator 505, which may be provided by a fine tunable local oscillator. The base band in-phase and quadrature signals are amplified at variable gain amplifiers 508a and 508b and filtered at low-pass filters 509a and 509b (preferably, with automatic gain control), which is then digitized at A/D converters 108a and 108b for further processing in base band processor 109.

The wide band IF receiver has good sensitivity and selectivity. In addition, the wide band IF receiver does not suffer from DC offset and 1/f noise problems, if a high IF is selected, although some corrections may be required if a relatively low IF is selected. Typically, however, the wide band IF receiver requires analog IF tunable mixer and multi-stage, high-order analog channel select low-pass filters to implement mixers 506a-506d and low-pass filters 509a and 509b. Such components are susceptible to phase noise from the IF image rejection mixers and to IQ mismatches.

In the transmitter, pre-distortion is a technique used to eliminate non-linearity. In the prior art, one pre-distortion technique is based on a model of non-linear distortion introduced into the transmitted signal given by:

y[n]=Σₖwₖx[n]|x[n]|^{k-1}

This model, however, is satisfactory only for weak non-linearity, and is unsatisfactory when the transmitter has high peak-to-average power ratio (PAR) and is required to operate over a wide bandwidth.

### SUMMARY

According to one embodiment of the present invention, a receiver uses a wideband intermediate frequency (IF) in the analog domain and performs low IF down-conversion in the digital domain, using low-power, high-speed, high-resolution analog-to-digital converters. The receiver can be integrated into an integrated circuit as one of several receivers. Such an integrated circuit may include multiple transmitters using adaptive non-linear modeling pre-distortion. The non-linear modeling may include memory. Imbalance in intermediate frequency in-phase and quadrature signals may be corrected in the digital domains. DC offsets in the intermediate signal may be corrected in both analog and digital domains. In one instance, the receiver provides a feedback receiver for the adaptive pre-distorter in a transmitter on the integrated circuit.

The present invention is better understood upon consideration of the detailed description below in conjunction with the drawings.

### BRIEF DESCRIPTION OF THE DRAWINGS

FIG. 1(a) is a block diagram of a first example of a conventional RF transceiver design.

FIG. 1(b) is a block diagram of a second example of a conventional RF transceiver design 120, in which D/A converter 107 and A/D converter 108 are integrated into digital base band processor 109.

FIG. 1(c) is a block diagram of a third example of a conventional RF transceiver design 120, in which D/A converter 107 and A/D converter 108 are integrated into RF transceiver 106.

FIG. 2 is a block diagram of conventional heterodyne receiver 200.

FIG. 3 is a block diagram of conventional homodyne receiver 300.

FIG. 4 is a block diagram of conventional low IF receiver 400.

FIG. 5 is a block diagram of conventional wide band IF receiver 500.

FIG. 6 is a block diagram of RF transceiver 600, in accordance with one embodiment of the present invention.

FIG. 7 shows a block diagram of wide band digital low IF receiver 700, which is an implementation of RF transceiver 600, according to one embodiment of the present invention.

FIG. 8 is a block diagram of programmable wide band digital low IF receiver 800, according one embodiment of the present invention.

FIG. 9 is a block diagram of DC offset correction circuit 900, in accordance with one embodiment of the present invention.

FIG. 10 is a block diagram of DC offset correction circuit 1000, in accordance with one embodiment of the present invention.

FIG. 11 is a block diagram for digital circuit 1100 for correcting IQ imbalance, including adaptive digital LMS filter 1101, in accordance with one embodiment of the present invention.

FIG. 12 is a block diagram showing conceptually a transmitter circuit 1200 with adaptive pre-distortion, according to one embodiment of the present invention.

FIG. 13 shows an implementation of an odd 5^{th} order non-linear pre-distorter with memory of up to 2 sample delays, according to one embodiment of the present invention.

FIG. 14 is a block diagram of transmitter circuit 1400 including pre-distortion based on a non-linear model with memory, in accordance with one embodiment of the present invention.

FIG. 15 is a block diagram illustrating an integrated circuit implementation of two transmitters and three receivers, in accordance with one embodiment of the present invention.

FIG. 16 is a block diagram of second integrated circuit 1600, which implements one transmission chain and two receiver chains, one of which capable of providing pre-distortion coefficient training.

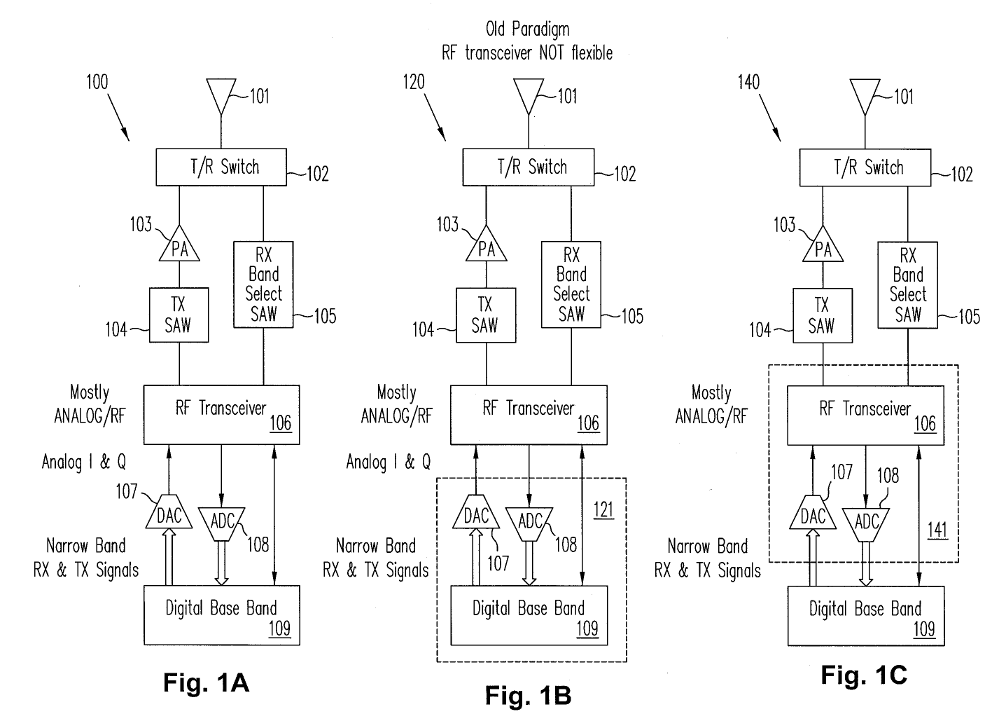

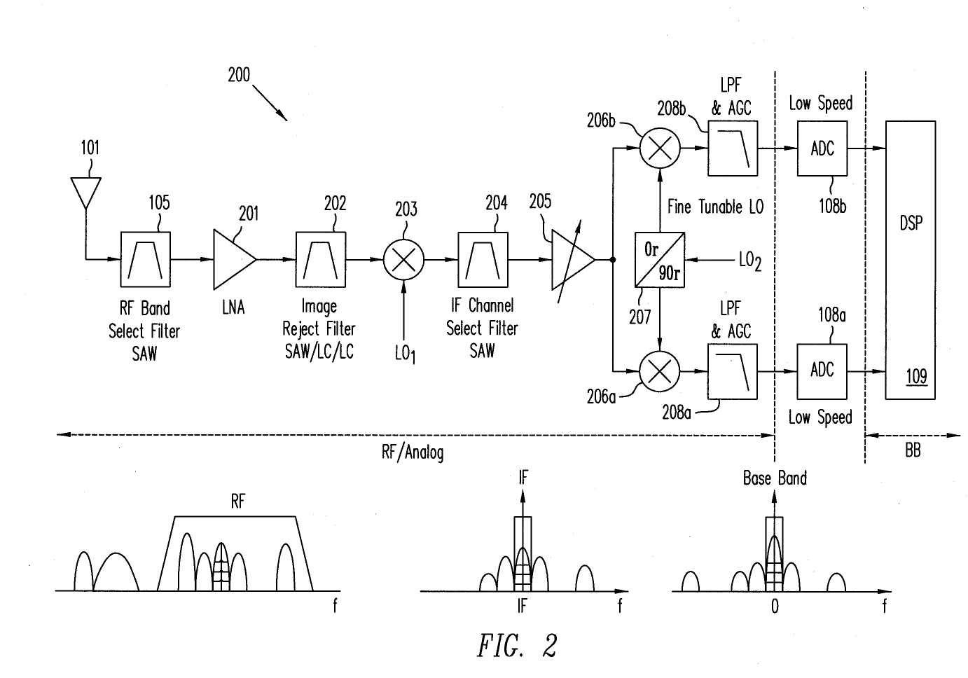

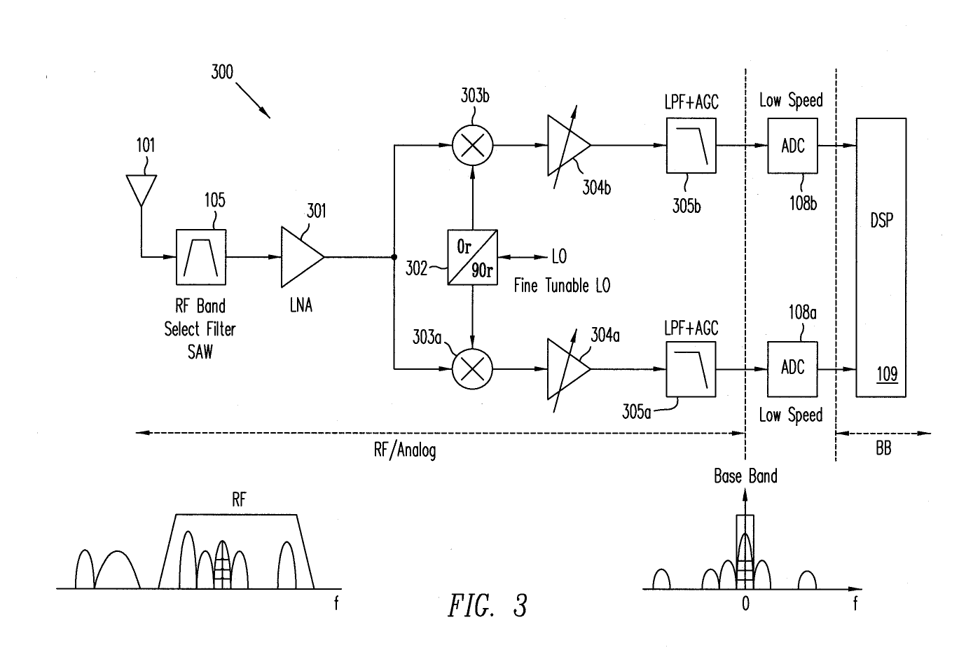

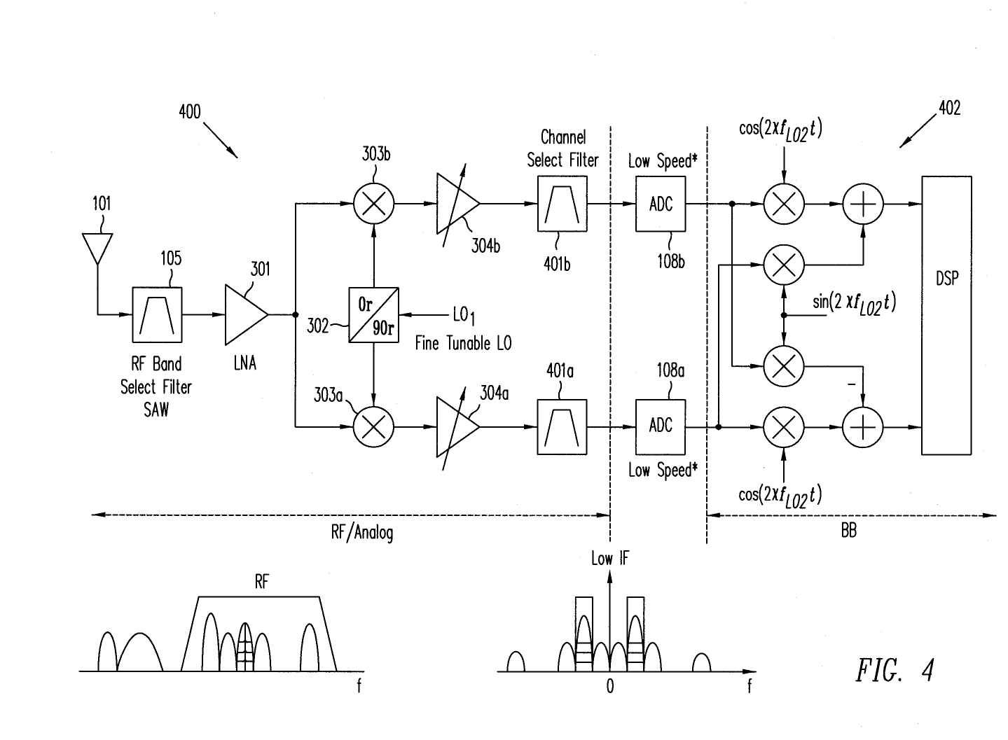

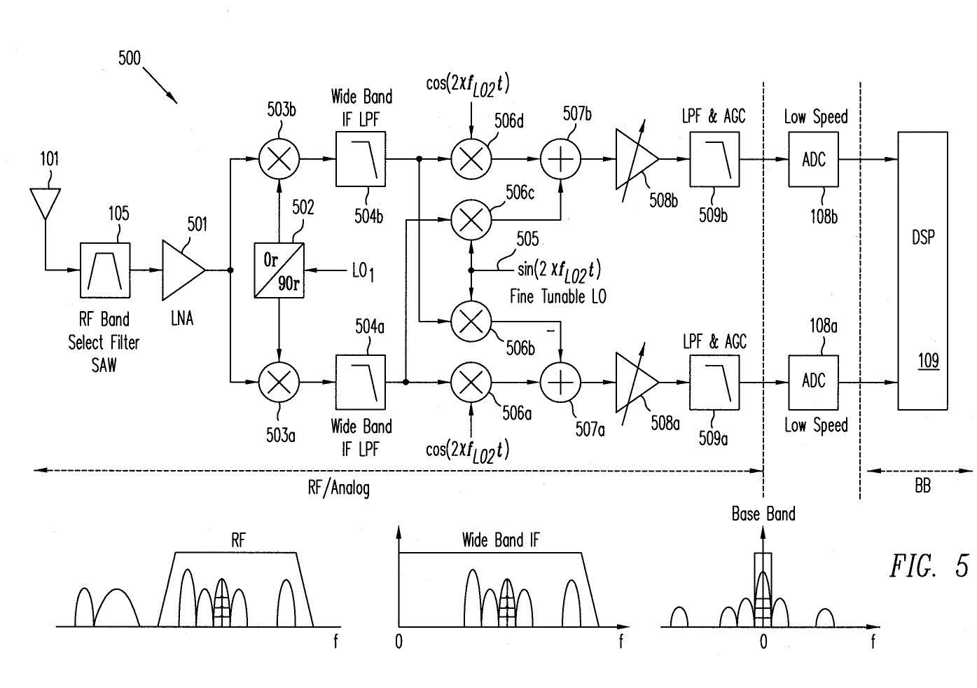

To facilitate cross-reference among the figures, like elements in the figures are assigned like reference numerals.

### DETAILED DESCRIPTION OF THE PREFERRED EMBODIMENTS

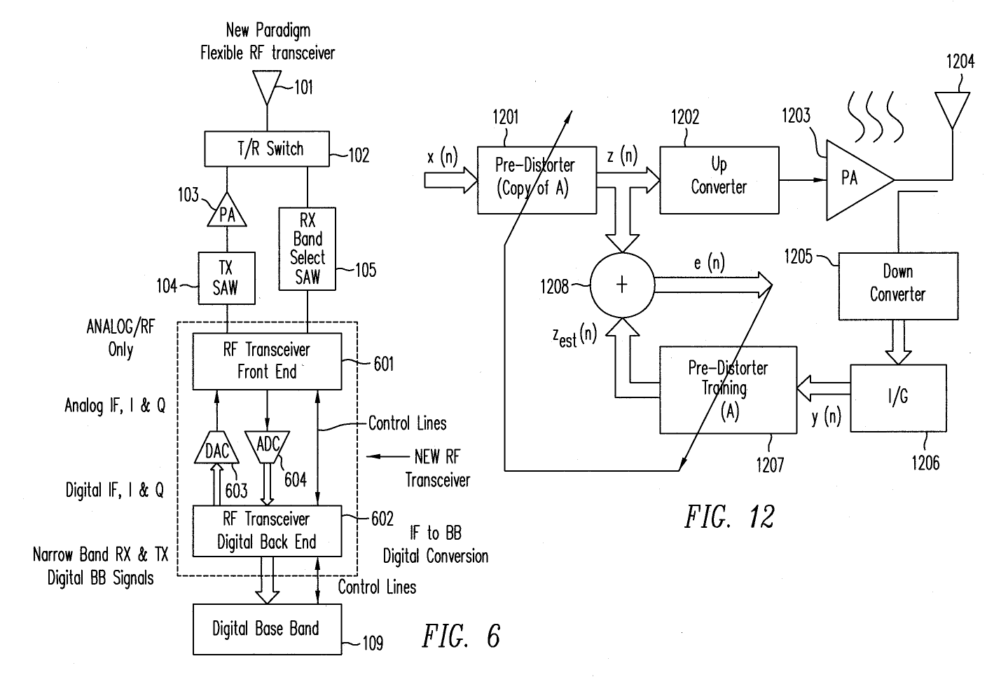

According to one aspect in one embodiment of the present invention, a transceiver is provided that processes received RF signals and provides a wide band low IF signal, which is then digitized by an A/D converter to provide a wide band digital IF signal. Wide band low IF refers to a wide band (with bandwidth much greater than the desired base band signal of interest) signal with its lowest frequency not very far from DC (i.e., 0 Hz). The digitized signal is then digitally down-converted for base band processing. FIG. 6 is a block diagram of RF transceiver 600, in accordance with one embodiment of the present invention. As shown in FIG. 6, RF transceiver 600 includes antenna 101, which is shared between transmitting and receiving operations under control of transmitter/receiver switch 102. When transmitting, the narrow-band, base band signal to be transmitted is prepared in digital base band processor 109 and provided to RF transceiver digital backend circuit 602, where the base band signal is digitally up-converted to a digital wide band IF signal. D/A converter 603 then converts the digital wide band IF signal into an analog signal, which is received into RF transceiver front end 601, where the signal is filtered and up-converted (e.g., modulated onto a carrier signal) for transmission. SAW filter 104 is typically provided to limit the output signal to the selected band. Power amplifier 103 then drives the filtered signal onto antenna 101 through transmitter/receiver switch 102.

When receiving, the signal in antenna 101 is band-limited by receiver band select SAW filter 105. RF transceiver front end 601 then processes the filtered signal and down-converts the processed signal into an analog wide band IF signal, which is then digitized in A/D converter 604, which operates at twice the wide band IF frequency or higher. The digitized signal is then down-converted in RF transceiver digital back end 602 to base band for further processing in base band processor 109.

The receiver according to RF transceiver 600 of FIG. 6 has all the advantages of the heterodyne, homodyne, low IF and wide band IF receivers of the prior art: (a) high sensitivity and selectivity; (b) no need for an external image rejection filter, such that the resulting circuit is more amenable to integration, as requiring only minimal number of external components; and (c) reduced or non-existent 1/f noise and DC offset, due to digitizing at wide band low IF. The ability to digitize at wide band low IF is provided by low-power, high-speed, high-resolution A/D converters disclosed, for example, in (a) U.S. Pat. No. 7,369,080 (the “'080 patent”) to E. Iroaga et al., entitled “Method and System for Driver Circuits of Capacitive Loads,” filed Sep. 14, 2006, and issued on May 6, 2008; and (b) U.S. patent application (the “'372 application”, entitled “Method and System for FET-based Amplifier Circuits,” by Jason Hu, Ser. No. 11/700,372, filed Jan. 31, 2007. The disclosures of the '080 patent and the '372 application are hereby incorporated by reference in their entireties to provide background technological information.

Reduced power consumption in the A/D converters disclosed in the '080 patent and '372 patent Application, for example, is achieved using simple (i.e., non-precision) amplifiers for A/D converter stages, unlike conventional A/D converters, which are typically provided by very high precision, accurate amplifiers that require 20-50 times the number of transistors than the simple amplifiers used in the A/D converter stages disclosed in the '080 patent. Such savings in transistors represent significant power savings. The price one pays for using such simple amplifiers is the requirement for extensive digital calibration to correct the non-ideal circuit characteristics. Digital calibration provides the requisite high precision and high resolution. However, with the high level integration in logic circuits, the requisite 10-20 thousand transistors to implement on-chip digital calibration of the A/D converters are a small price in silicon real estate and power. Using this technique, it is estimated that performance levels of 12-bit, 100 mega-samples per second (MS/s) can be achieved at 10-12 mW, which is at least an order of magnitude in both power saving and performance aspects over conventional A/D converters.

The ability to down-convert a wide band IF signal to base band in the digital domain allows great flexibility not achieved in conventional RF receiver circuits. Digital down-conversion allows programmability in (a) channel selection; (b) filtering and base band bandwidth selection; (c) adaptive IQ imbalance correction; (d) adaptive DC offset correction (when needed, discussed below); (e) instantaneous re-programmability in channel and bandwidth selections; (f) scalable architecture for multi-channel operation; and (g) possible integration with the base band processor. Filtering and quadrature processing in the wide band IF range avoid 1/f noise and DC offsets.

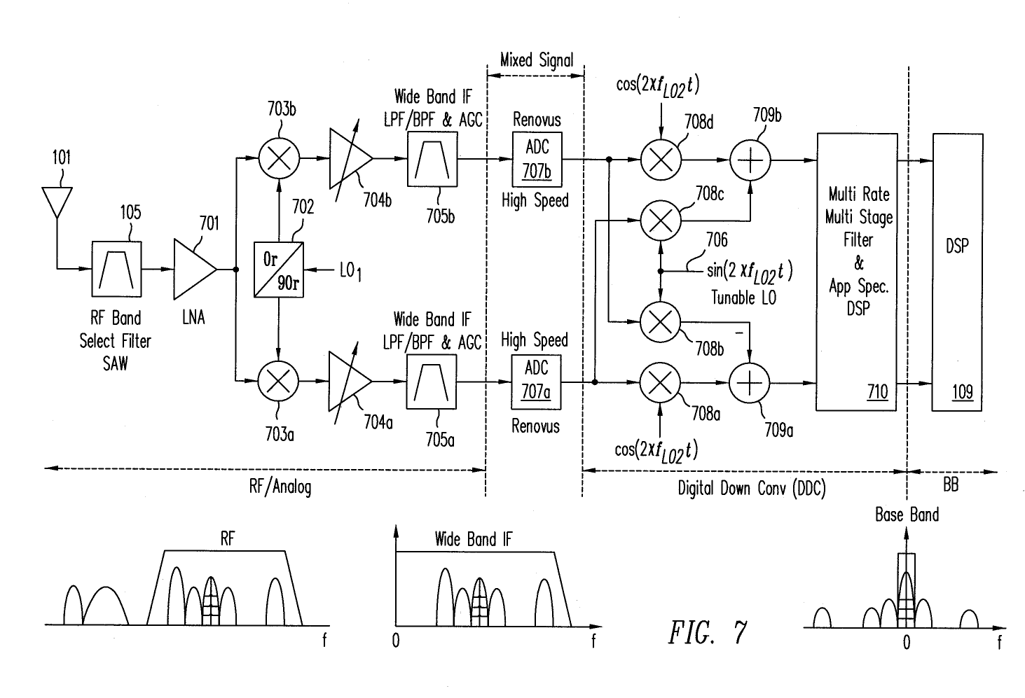

According to one embodiment of the present invention, one implementation of RF transceiver 600 is illustrated by wide band digital low IF receiver 700 of FIG. 7. As shown in FIG. 7, wide band low IF receiver 700 includes LNA 701, which amplifies a band-limited signal from band select filter 105. The filtered signal is then down-converted at local oscillator 702 and mixed at mixers 703a and 703b to provide in-phase and quadrature signals at a wide band IF. The wide band in-phase and quadrature IF signals are amplified at variable gain amplifiers 704a and 704b and filtered at low-pass or band-pass filters 705a and 705b (preferably, with automatic gain control), which is then digitized at A/D converters 707a and 707b. A/D converters 707a and 707b, such as any of those disclosed in the '080 patent and the '372 application (incorporated by reference above), digitize the wide band in-phase and quadrature IF signals to provide corresponding digital signals. Fine tunable local oscillator 706, mixers 708a-708b and summers 709a and 709b down-converts the digital wide band in-phase and quadrature IF signals to digital in-phase and quadrature low IF signals. These low IF signals can be further processed for channel selection, rate-matching, filtering and other digital signal processing in logic circuit 710. In one implementation, an application specific integrated circuit (ASIC), which includes multi-rate, multi-stage filters and other applications, implements logic circuit 710. Further digital processing (e.g., demodulation) may be carried out in digital processor 109.

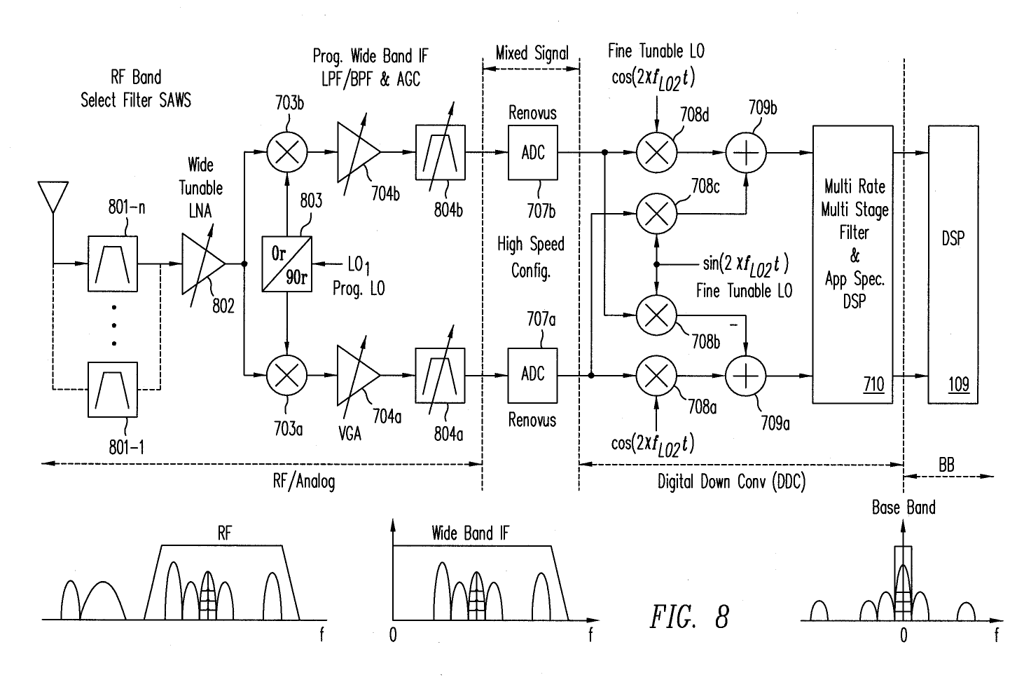

The programmable receiver architecture illustrated by RF transceiver 700 of FIG. 7 is particularly suited for use in mobile devices. In the prior art, multiple RF transceivers are provided in such mobile device to handle the signals of various wireless communication standards, such as GSM, CDMA, WiFi, WiMax and others. Together with programmable analog components, the programmable receiver architecture of RF receiver 700 may be extended to provide a programmable RF circuit that can be shared in a mobile device for use with two or more of the supported wireless communication standards. One example of such a receiver is shown in FIG. 8. FIG. 8 is a block diagram of programmable wide band digital low IF receiver 800, according one embodiment of the present invention. As shown in FIG. 8, a number of RF band select filters 801-1 to 801-n is provided to select the desired signal to be received. Wide tunable LNA 802 then amplifies the signal of the selected band. The amplified signal is then down-converted at programmable local oscillator 803 and mixed at mixers 703a and 703b to provide in-phase and quadrature signals at a programmable wide band IF. The wide band in-phase and quadrature IF signals are then amplified at variable gain amplifiers 704a and 704b and filtered at programmable low-pass or band-pass filters 804a and 804b (preferably, with automatic gain control), which is then digitized at A/D converters 707a and 707b. Fine tunable local oscillator 706, mixers 708a-708b and summers 709a and 709b down-converts the digital wide band in-phase and quadrature IF signals to digital in-phase and quadrature low IF signals. These low IF signals can be further processed for channel selection, rate-matching, filtering and other digital signal processing in logic circuit 710. In one implementation, an application specific integrated circuit (ASIC), which includes multi-rate, multi-stage filters and other applications, implements logic circuit 710. Further digital processing (e.g., demodulation) may be carried out in digital processor 109.

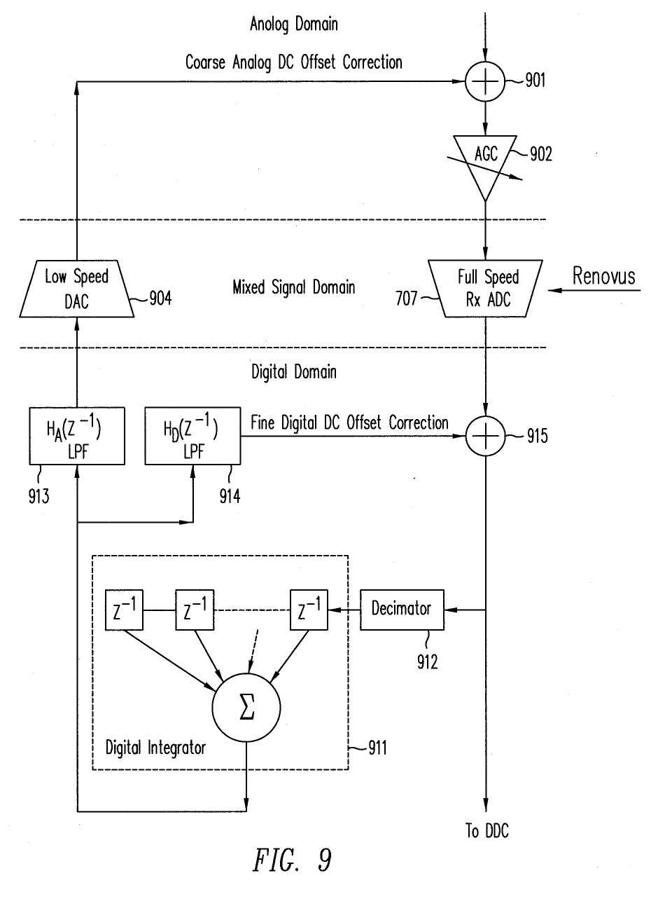

As discussed above, one aspect of the present invention allows adaptive correction to a DC offset in the RF transceiver. According to that aspect of the present invention, adaptive DC offset correction is carried out in part in the analog domain and in part in the digital domain. FIG. 9 is a block diagram of DC offset correction circuit 900, in accordance with one embodiment of the present invention. As shown in FIG. 9, a received analog signal (e.g., one of the wide band IF in-phase or quadrature signals discussed above) receives a coarse analog DC offset correction signal at summer 901, which is used to adjust the received analog signal to be substantially free of DC offset. This coarse analog DC offset correction signal is further discussed below. The adjusted signal is then amplified by automatic gain control (AGC) amplifier 902 to take advantage of the full dynamic range of A/D converter 707 (e.g., either one of A/D converters of FIG. 7 or 8). D/A converter 707 then digitized the adjusted signal. The digitized signal is summed with a fine digital DC offset correction signal at summer 915 to further adjust any residual DC offset in the digitized signal. The adjusted digital signal is then down-converted in the digital domain, as discussed above with respect to FIGS. 7 and 8 above. To derive the coarse analog and fine digital DC offset correction signals, the adjusted digital signal is decimated at 1:N decimator 912, as high resolution is not required to derive the DC offset correction signals. The decimated signal is averaged over time in digital integrator 911 to obtain the DC offset in the adjusted digital signal. Digital low-pass filters 913 and 914 are provided to obtain the higher and lower order bits of the DC offset for the analog and digital DC offset correction signals, respectively. Low speed conventional D/A converter 904 is adequate to feed back the analog coarse DC offset correction signal. The fine digital offset correction signal provides both fine cancellation of the DC level in the digital domain and cancellation of any time-varying DC offset resulting from such effects as reflections from transmitted signals.

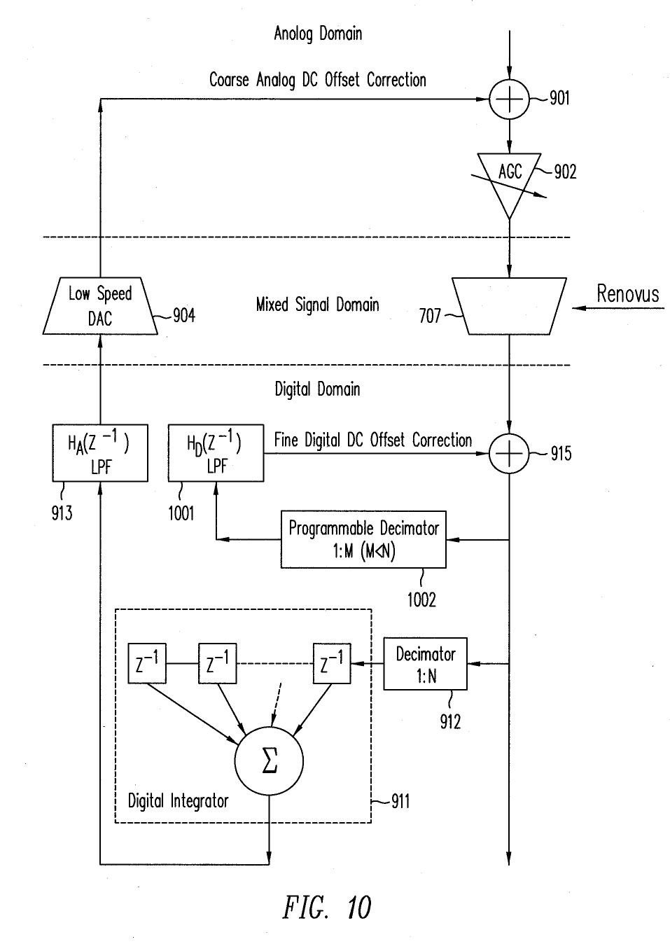

FIG. 10 is a block diagram of DC offset correction circuit 1000, in accordance with one embodiment of the present invention. DC offset correction circuit 1000 is an alternative implementation to DC offset correction circuit 900. In DC offset correction circuit 1000, rather than deriving the fine digital DC correction signal from the output signal of digital integrator 911, a separate low-pass filter 1001 provides the fine digital DC offset correction signal, which can now be provided at a higher resolution than digital integrator 911. This higher resolution is provided by programmable decimator 1002, which provides a lower 1-in-M decimation rate than the 1-in-N decimation of decimator 912 to provide an even finer correction signal.

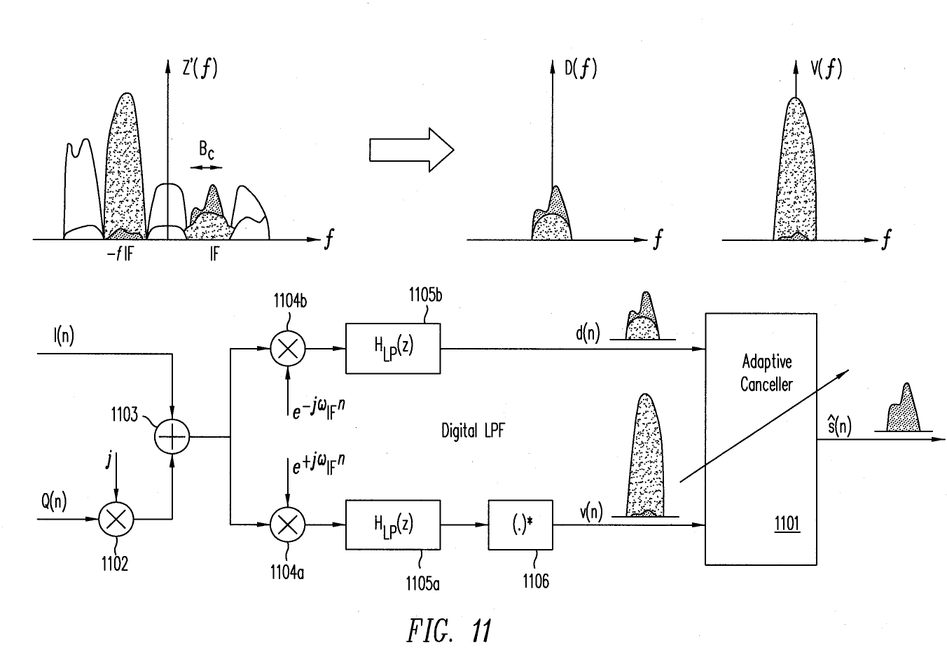

According to another aspect of the present invention, using an adaptive filter, IQ imbalance correction may take into consideration all factors (e.g., branch filters, AGC and A/D converters) affecting IQ imbalance. Under this approach, interference from the image signal is treated as a broadband cross-talk, and thus may be canceled using a linear cross-talk canceller. FIG. 11 is a block diagram for digital circuit 1100 for correcting IQ imbalance, including adaptive digital least mean squares (LMS) filter 1101, in accordance with one embodiment of the present invention. As shown in FIG. 11, in-phase digital IF signal I[n] and a rotated quadrature digital IF signal Q[n] (rotated at mixer 1102) are summed at summer 1103 to form a complex signal. The complex signal is down-converted at mixers 1104a and 1104b by mixing the complex signal with complex IF carrier signals e^{jω}^{_{IF}}ⁿ and e^{-jω}^{_{IF}}ⁿ. The resulting down-converted signals are low-pass filtered at low-pass filters 1105a and 1105b to recover base band signal d[n] and image signal ν[n], respectively. (A complex conjugate circuit 1106 provides the magnitude of the image signal). Under IQ imbalance, however, these signals are modeled as being corrupted by cross talk. Thus, estimates Ŝ and Ŝ₁ for the true (i.e., corrected) base band signal S and the true image signal S₁ are given by:

Ŝ[n]=d[n]−Σₖwₖν[n−k]

Ŝ₁[n]=ν[n]−Σₖgₖd[n−k]

where wₖ and gₖ are the coefficients characterizing the cross talk. The goal is to iteratively updates coefficients wₖ and gₖ using the fact that the true (i.e., corrected) base band signal S and the true image signal S₁ are uncorrelated. For a filter length N, digital adaptive LMS filter 1101 is characterized by:

W[n]=[w₀[n],w₁[n], . . . , w_{N-1}[n]]^{T}

G[n]=[g₀[n],g₁[n], . . . , g_{N-1}[n]]^{T}

d[n]=[d[n],d[n−1], . . . , d[n−N+1]]^{T}

ν[n]=[ν[n],ν[n−1], . . . , ν[n−N+1]]^{T}

S[n]=d[n]+W^{T}ν[n]

S₁[n]=ν[n]+G^{T}d[n]

S[n]=[S[n],S[n−1], . . . , S[n−N+1]]^{T}

S₁[n]=[S₁[n],S₁[n−1], . . . , S₁[n−N+1]]^{T}

The update equations of digital adaptive LMS filter 1101 are then given by:

W[n+1]=W[b]+US[n]S₁[n]

G[n+1]=G[b]+VS[n]S₁[n]

U=diag{u₀,u₁, . . . , U_{N}}

V=diag{v₀,v₁, . . . , V_{N}}

where the values of u₀,u₁, . . . , u_{N} and v₀,v₁, . . . , v_{N} are elements of the LMS step-size matrices. As is known to those skilled in the art, these values are selected by the programmer or the filter designer to control step sizes that determine the rate at which the solution converges to an acceptable value.

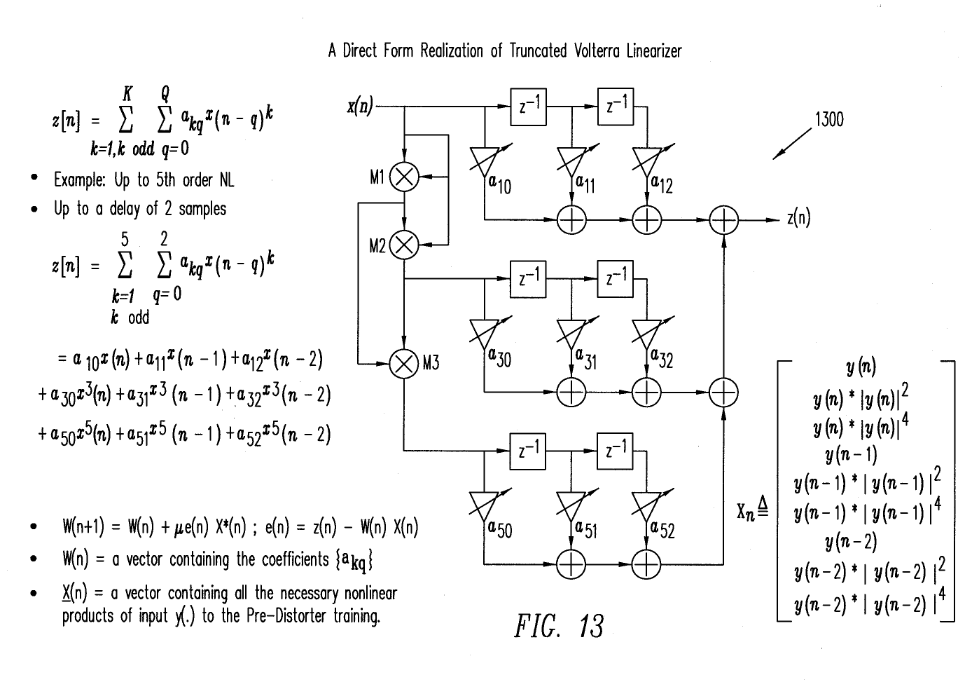

According to one embodiment of the present invention, a transmitter with adaptive pre-distortion improves linearity for a transmitter that operates in both high PAR and wide bandwidth conditions. FIG. 12 is a block diagram showing conceptually a transmitter circuit 1200 with adaptive pre-distortion, according to one embodiment of the present invention. As shown in FIG. 12, digital signal x[n] to be transmitted is pre-distorted in pre-distorter 1201. The resulting pre-distorted signal z[n] is then up-converted and converted into the analog format in up-converter circuit 1202 and transmitted through antenna 1204, driven by power amplifier 1203. To adaptively adjust pre-distorter 1201 to achieve linearity, a receiver is provided which feeds back the transmitted signal. The receiver includes down-converter 1205 and gain control 1206 (which represents also signal amplification, A/D conversion and filtering) to provide digital signal y[n]. Ideally, the purpose of adaptive pre-distorter 1201 is to pre-distort the signal transmitted, such that the received signal y[n] is a scaled version of signal x[n]. Pre-distorter training circuit 1207 is provided, therefore, to train the coefficients of pre-distorter 1201. Signal y[n] is filtered in pre-distorter training circuit 1207 to provide estimate \hat{z}[n], which estimates output signal z[n] of pre-distorter 1201. Summer 1208 subtracts estimate \hat{z}[n] from output signal z[n] to provide error signal e[n]. In one embodiment of the present invention, the non-linearity in the transmitter is modeled by:

y[n]=ΣₖΣ_{q}a_{kq}x[n−q]|x[n−q]|^{k-1}

In one embodiment, adaptive transmitter circuit 1200 can be implemented using an minimum mean-square error (MMSE) filter (i.e., the coefficients a_{kq}, are such which minimize the expected value E{|e[n]|²}). Adaptation of coefficients a_{kq} may be provided via an least mean square (LMS) algorithm or a recursive least square (RLS) algorithm. Using LMS (i.e., stochastic gradient), the adaptation equations are given by:

A[n+1]=A[n]+μe[n]X[n]

e[n]=z[n]−A[n]X[n]

where A[n] is the vector containing coefficients a_{kq} and X[n] is a vector including all the necessary non-linear products of signal y[n].

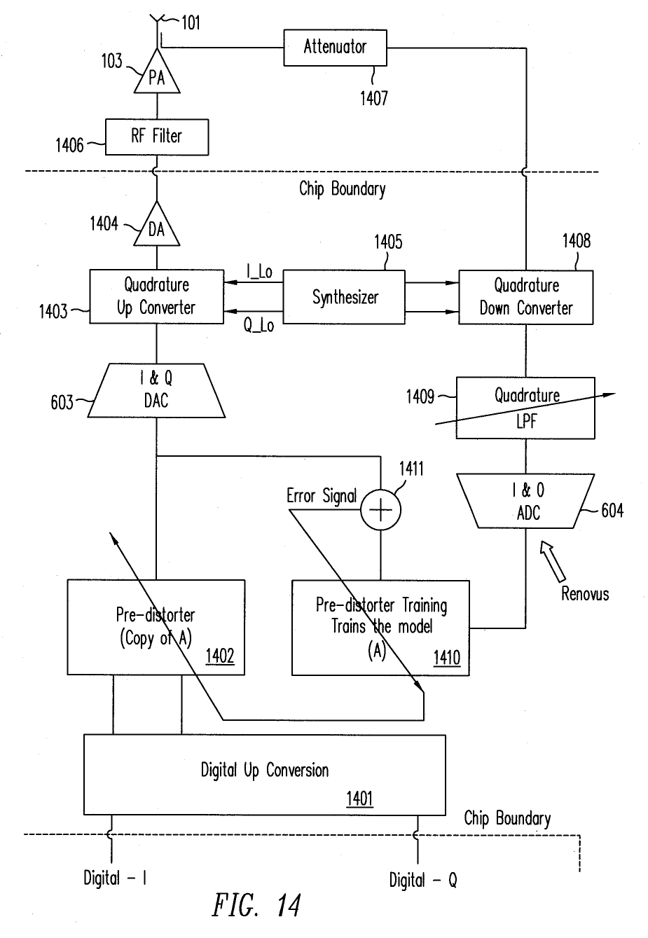

One example of a pre-distorter using this approach is provided in FIG. 13. FIG. 13 shows an implementation of an odd 5^{th} order non-linear pre-distorter 1300 with memory of up to 2 sample delays (i.e., k=1, 3, 5; q=0, 1, 2), according to one embodiment of the present invention. Digital filter 1300 implements the pre-distorter z[n]=Σ_{k=1,3,5} Σ_{q=0,1,2}a_{kq}x[n−q]^{k}. The adaptation equations are:

W[n+1]=W[n]+μe[n]X[n]

e[n]=z[n]−W[n]X[n]

W[n]=[a₁₀a₃₀a₅₀a₁₁a₃₁a₅₁a₁₂a₃₂a₅₂]

X[n]=[y[n]y[n]³y[n]⁵y[n−1]y[n−1]³y[n−1]⁵y[n−2]y[n−2]³y[n−2]⁵]^{T}

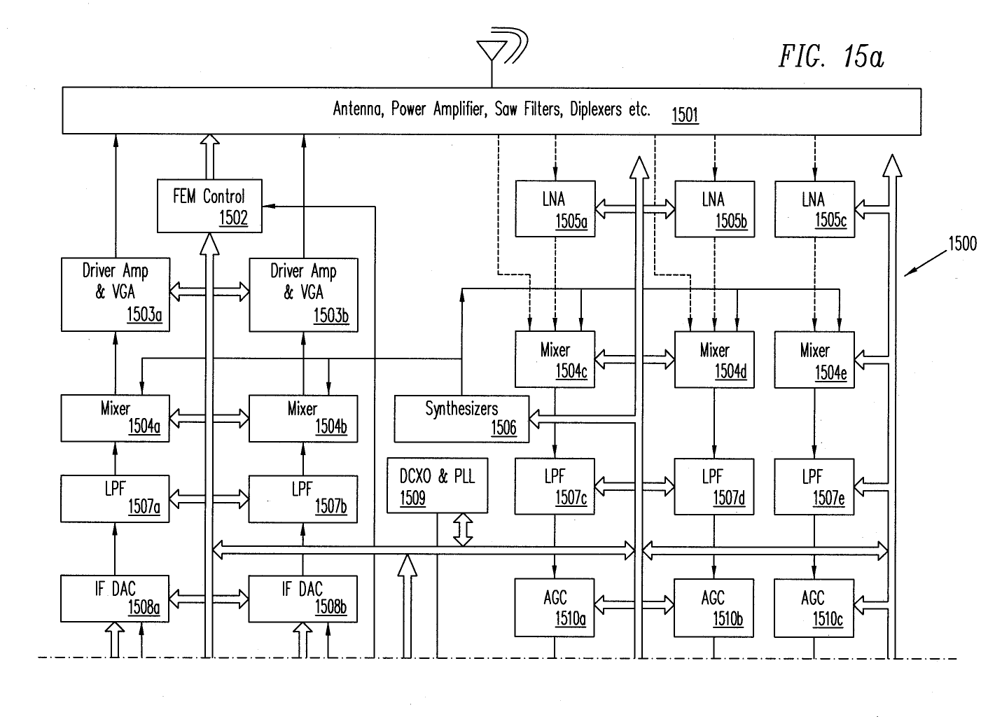

FIG. 14 is a block diagram of transmitter circuit 1400 including pre-distortion based on a non-linear model with memory, in accordance with one embodiment of the present invention. As shown in FIG. 14, digital in-phase and quadrature signals are up-converted to wide band IF in up-conversion circuit 1405, which is then pre-distorted in pre-distorter 1402, the pre-distorted in-phase and quadrature signals are then converted to analog form in D/A converter 603, which is then further up-converted in up-conversion circuit 1403 with a target carrier frequency generated by local oscillator or synthesizer 1405. The in-phase and quadrature signals are combined, amplified by driver amplifier 1404 and filtered in RF filter 1406 and transmitted over antenna 101, driven by power amplifier 103. Attenuator 1407 receives the transmitted signal at the output terminal of power amplifier 103. The attenuated signals are then converted to wide band IF in-phase quadrature signals in quadrature down-conversion circuit 1408, which are then low-pass filtered for image rejection in quadrature low-pass filter 1409. The filtered in-phase and quadrature wide band IF signals are then digitized in A/D converter 604, and provided to pre-distorter training filter 1410. Summer 1411 provides an error signal based on the output signals of pre-distorter 1402 and pre-distorter training filter 1410. Digital signal processing based on minimizing an expected mean-square of this error signal derives the next set of filter coefficients for the pre-distorter 1402.

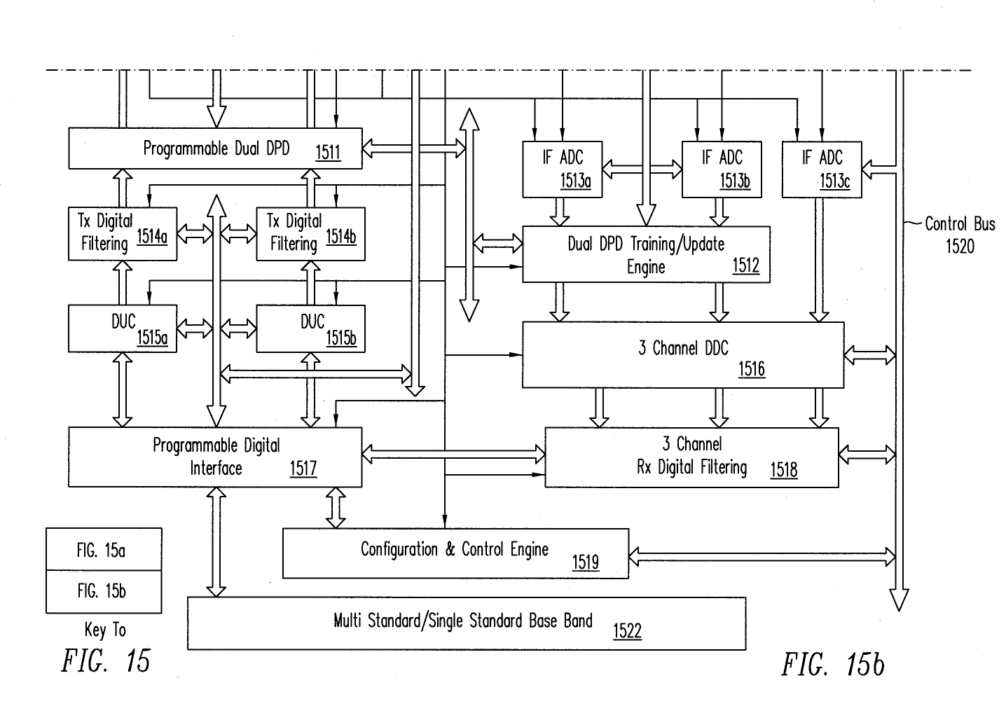

The transmitters and receivers discussed above can be implemented integrated in various ways into one or more integrated circuits. FIG. 15 is a block diagram illustrating integrated circuit 1500, which implements two transmitters and three receivers, in accordance with one embodiment of the present invention. As shown in FIG. 15, integrated circuit 1500 includes interfaces 1501 to external analog components (e.g., antennae, power amplifiers, SAW filters, and diplexers) and interface 1517 to base band processor 1522. Within integrated circuit 1500, front-end module (FEM) control 1502 allows integrated circuit 1500 to control external conventional analog RF front-end modules. Digitally controlled crystal oscillator and phase-locked loop circuits 1509 is provided for any timing use throughout integrated circuit 1500. Configuration and control engine 1519 provides control and configuration signals throughout integrated circuit 1500 over control bus 1520.

As shown in FIG. 15, a base band signal for transmission is provided to one of digital up-conversion circuits (DUC) 1515a and 1515b, which modulates the filtered signals onto a wide band IF. Each DUC belongs to one of the two transmitter chains in integrated circuit 1500. DUC 1515a and 1515b can each be used to implement digital up-conversion circuit 1401 of FIG. 14, for example. Transmitter digital filters 1514a and 1514b are provided to perform necessary filtering of the up-converted signals.

Programmable dual digital pre-distortion (DPD) circuit 1511 pre-distorts the filtered up-conversion signal to eliminate non-linearity in the transmission chain, using coefficients trained in dual DPD training and update engine 1512, as discussed above. The pre-distorted signal is then converted into analog form by one of D/A converters 1108a and 1108b. D/A converters 1108a and 1108b may be provided by the D/A converters disclosed in the '080 patent and the '372 patent Application discussed above. The analog signal is filtered in one of low-pass filters 1507a and 1507b and up-converted in one of mixers 1504a and 1504b for transmission. Mixers 1504a and 1504b are programmable to operate at any frequency generated in synthesizer 1506. Driver amplification and variable gain amplifiers 1503a and 1503b are provided to drive the signal to be transmitted off-chip for transmission. On the receiver side, each receiver chain is includes an LNA (LNA 1505a, 1505b and 1505c) programmable to be in the receiver chain for amplification of a received signal provided from off-chip or bypassed. The received signal is received into one of mixers 1504c, 1504d and 1505e and down-converted to a wide band IF; each mixer is programmable to operate in any frequency generated by synthesizer 1506. One of low-pass filters 1507c, 1507d and 1507e may be used for filtering (e.g., image rejection). Automatic gain control circuit 1510a, 1510b or 1510c adjusts the filtered signal (e.g., IQ imbalance and DC offset corrections) to the full dynamic range so as to allow conversion into digital format in one of A/D converters 1513a, 1513b and 1513c. Two of the receiver chains can provide their digitized signals to Dual DPD training or updating circuit 1516 to train pre-distortion coefficients for programmable dual DPD circuit 1511 in the transmitter chains. Alternatively, the digitized signal can be provided for down-conversion to base band in 3-channel digital down-conversion (DDC) unit 1516, and be further filtered in 3-channel receiver digital filtering unit 1518. The filtered signal is then provided to an off-chip base band processor through programmable digital interface 1517.

Integrated circuit 1500 thus provides a software programmable RF transceiver suitable for use in mobile and portable devices (e.g., cellular telephones, personal digital assistants, and portable computers) which are capable of wireless communication under two or more standards (e.g., MIMO, WLAN, WiMAX, WCDMA, LTE, and other 3GPP cellular standards). Under the present architecture, multiple receiver and transmitter channels can be configured and dynamically reconfigured by software to operate simultaneously, independently or cooperatively. For example, under a time-division duplexing (TDD) standard, one of the receiver channels can be used to receive incoming signals during the time slots for receiving, and for feeding back the transmitted signal for pre-distortion in the manner discussed above (see, e.g., in integrated circuit 1500, two of the three receiver chains can be used this way for the two transmitter chains).

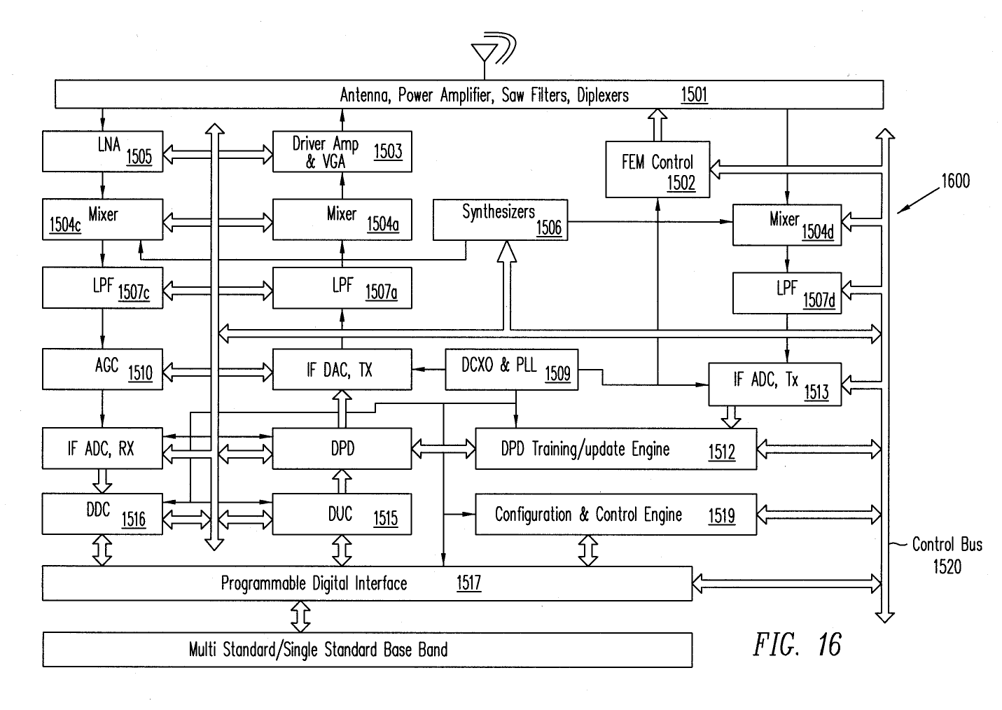

FIG. 16 is a block diagram of second integrated circuit 1600, which implements one transmission chain and two receiver chains, one of which capable of providing pre-distortion coefficient training in the manner discussed above. The transmitter and receiver chains in integrated circuit 1600 operate in substantially the same manner as corresponding transmitter and receiver chains in integrated circuit 1500; as such, their detailed description is therefore omitted.

The above detailed description is provided to illustrate the specific embodiments of the present invention and is not intended to be limiting. Numerous modifications and variations within the scope of the present invention are possible. The present invention is set forth in the following claims.

1. A multi-domain DC offset correction circuit, comprising:
a digital filter which low-pass filters the digitized intermediate frequency signal to provide a DC offset correction signal having a coarse DC offset correction component and a fine DC offset correction component; and
a digital-to-analog converter that converts the coarse DC offset correction component to an analog correction signal.

2. A correction circuit as in claim 1, wherein the analog correction signal is applied to an analog intermediate frequency signal.

3. A correction circuit as in claim 2, wherein the fine DC offset correction signal is applied to a digitized intermediate frequency signal.

4. A correction circuit as in claim 1, wherein the digitized intermediate frequency signal is a wide band signal.

5. A correction circuit as in claim 1, wherein the digitized intermediate frequency signal is decimated to a lower sampling rate prior to low-pass filtering in the digital filter.

6. A correction circuit as in claim 5, wherein the fine DC offset correction signal is at a lower sampling rate relative to the digitized intermediate frequency signal but at a higher sampling rate relative to the coarse DC offset correction component.

7. A correction circuit as in claim 1, wherein the wide band signal includes an intermediate frequency signal having a carrier frequency exceeding 0 Hz.

8. A method for correcting DC offset correction, comprising:
low-pass filtering in the digital domain a digitized intermediate frequency signal to provide a DC offset correction signal having a coarse DC offset correction component and a fine DC offset correction component; and
converting the coarse DC offset correction component into analog form to provide an analog correction signal.

9. A method as in claim 8, further comprising applying the analog correction signal to an analog intermediate frequency signal.

10. A method as in claim 9, further comprising applying the fine DC offset correction signal to a digitized intermediate frequency signal.

11. A method as in claim 10, wherein the digitized intermediate frequency signal is a wide band signal.

12. A method as in claim 8, wherein the wide band signal includes an intermediate frequency signal having a carrier frequency exceeding 0 Hz.

13. A method as in claim 8, wherein the digitized intermediate frequency signal is a wide band signal.

14. A method as in claim 8, wherein the fine DC offset correction signal is at a lower sampling rate relative to the digitized intermediate frequency signal but at a higher sampling rate relative to the coarse DC offset correction component.
